(19) United States
(12) Patent Application Publication
(10) Pub. No.: US 2010/0229079 A1
(43) Pub. Date: Sep. 9, 2010

(54) INFORMATION PROCESSING APPARATUS AND INFORMATION PROCESSING METHOD

(75) Inventors: Tooru Ishizaki, Kawasaki-shi (JP); Wataru Suzuki, Kawasaki-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/279,973

(22) PCT Filed: Feb. 20, 2007
(86) PCT No.: PCT/JP2007/053458

§ 371 Date: Aug. 19, 2008

(30) Foreign Application Priority Data
Feb. 22, 2006 (JP) 2006-045860
Jan. 16, 2007 (JP) 2007-007459

(51) Int. Cl. G06F 17/00

(52) U.S. Cl. 715/205; 715/234

(57) ABSTRACT

The page division unit which contains link information is updated by merging an image data indicated by the link information into the start of the page division unit, and changing a link destination indicated by the link information to the image data (S505).

### TECHNICAL FIELD

The present invention relates to a technique for handling an external data and document data which contains link information representing a link to the external data.

### BACKGROUND ART

When storing or transferring a structured document which contains link information representing a link to reference information such as image data, the structured document and the reference information are sometimes combined for the sake of efficiency. Conventionally, the reference information is encoded by base64 to embed it in the portion where the link information is written. Also, an XML document and the reference information as individual parts are combined into one package by, e.g., MTOM (SOAP Message Transmission Optimization Mechanism) of W3C.

Also, the reference information is directly inserted into the reference portion of the structured document using a specific delimiter by “The MIME Application/Vnd.pwg-multiplexed Content-Type” defined by the IETF specification to combine them.

In the above-described conventional techniques, problems occur when the same reference information is referred to from a plurality of portions of the structured document.

A device with a small resource needs to sequentially process input data so as not to accumulate them. To meet this requirement, the reference information is copied for each reference portion, and the copied pieces of information are inserted into the structured document to combine them. In this case, although the combined data can be sequentially processed, the amount of the combined data is much larger than that of uncombined data, resulting in an increase in cost for data transfer.

When the reference information is not copied but is attached to the structured document to combine them so as to refer to the attached reference information from a plurality of portions, the data amount does not become large. However, it is unknown how long the reference information should be retained in processing the combined data, and the reference information must be retained until the combined data is completely processed. The device having a small resource cannot therefore process a large size of reference information such as image data.

In order to solve such problems, the combined data must be sequentially processed even by the device with the small resource by combining the structured document and the reference information into one part without any duplicated data.

### DISCLOSURE OF INVENTION

The present invention has been made in consideration of the above problem, and has as its object to provide a technique for efficiently managing an external data and document data which contains link information representing a link to the external data.

In order to achieve an object of the present invention, for example, an information processing apparatus of the present invention comprises the following arrangement.

That is, an information processing apparatus which processes document data which contains link information representing a link to external data, comprising:

determination unit adapted to determine, when generating a plurality of divided document data by dividing the document data, whether the link information is written in each divided document data; and

updating unit adapted to update the divided document data determined by the determination unit to contain the link information, by including the determined divided document data and the external data indicated by the link information, and changing the link destination indicated by the link information to the included external data.

In order to achieve an object of the present invention, for example, an information processing method of the present invention comprises the following arrangement.

That is, an information processing method executed by an information processing apparatus processes document data which contains link information representing a link to external data, comprising:

a determination step of determining, when generating a plurality of divided document data by dividing the document data, whether the link information is written in each divided document data; and

a updating step of updating the divided document data determined in the determination step to contain the link information, by including the determined divided document data and the external data indicated by the link information, and changing the link destination indicated by the link information to the included external data.

Further features of the present invention will become apparent from the following description of exemplary embodiments with reference to the attached drawings.

### BRIEF DESCRIPTION OF DRAWINGS

FIG. 1 is a block diagram showing the arrangement of a system including a computer to which an information processing apparatus is applied according to the first embodiment of the present invention;

FIG. 2 is a block diagram showing the hardware arrangement of a computer 101;

FIG. 3 is a view showing an arrangement example of a document file handled by the computer 101 according to the first embodiment of the present invention;

FIG. 4 is a flowchart showing processing executed by the computer 101;

FIG. 5 is a flowchart showing processing executed by the computer 101;

FIG. 6 is a view showing an arrangement example of a document file obtained by updating the document file shown in FIG. 3 in accordance with the flowchart of FIG. 4;

FIG. 7 is a view showing an arrangement example of a document file obtained by updating the document file shown in FIG. 3 in accordance with the flowchart of FIG. 5;

FIG. 8 is a view showing document data archived by a computer 101 according to the third embodiment of the present invention; and

FIG. 9 is a flowchart showing processing executed by the computer 101 which archives a plurality of files such as the document files and image files into one file.

### BEST MODE FOR CARRYING OUT THE INVENTION

Preferred embodiments of the present invention will now be described in detail in accordance with the accompanying drawings.

### First Embodiment

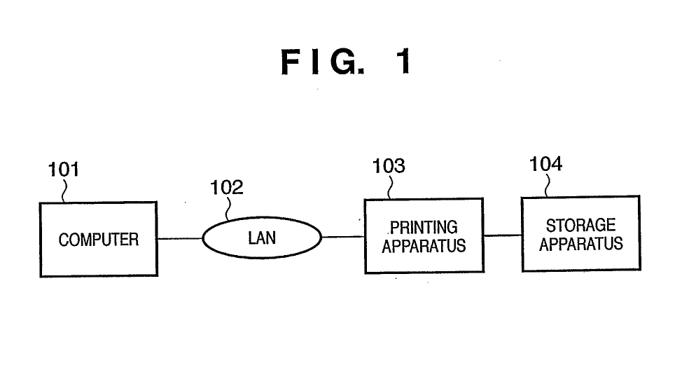

FIG. 1 is a block diagram showing the arrangement of a system including a computer to which an information processing apparatus is applied according to the first embodiment. Referring to FIG. 1, the system in this embodiment includes a computer 101, printing apparatus 103, and storage apparatus 104. The computer 101 and the printing apparatus 103 are connected to a LAN 102. The storage apparatus 104 is connected to the printing apparatus 103. The network between the computer 101 and the printing apparatus 103 is not limited to the LAN 102. The network may be the Internet or the like.

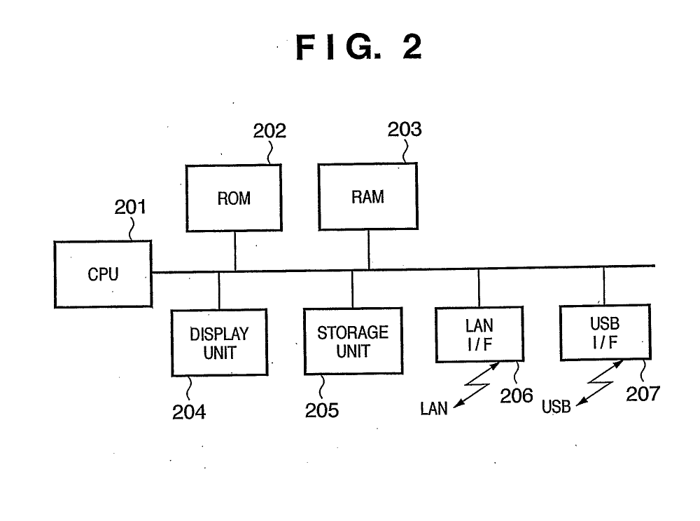

The computer 101 will be described first. FIG. 2 is a block diagram showing the hardware arrangement of the computer 101. A CPU 201 uses a program or data stored in a ROM 202 or a RAM 203 to control the computer 101 as a whole, control data communication between the computer 101 and the printing apparatus 103 via the LAN 102, and the like. This is, the CPU 201 executes processes (to be described later) of the computer 101.

The ROM 202 stores the setting data, boot program, and the like of the computer 101.

The RAM 203 has, for example, an area for temporarily storing a program or data loaded from a storage unit 205 and data received from an external apparatus via an LAN I/F 206, and a work area used when the CPU 201 executes the processes. That is, the RAM 203 can provide various kinds of areas as needed.

A display unit 204 comprises a CRT or liquid crystal screen, and displays a process result from the CPU 201 using image and text data.

The storage unit 205 is a large-capacity information storage device represented by a hard disk drive device. The storage unit 205 stores an OS (Operating System) or a program or data for causing the CPU 201 to execute the processes (to be described later) of the computer 101. The data contains document data to be described later. The program or data stored in the storage unit 205 is loaded into the RAM 203, as needed, under the control of the CPU 201. The CPU 201 executes the processes by using the loaded program or data.

The LAN I/F 206 is used to connect the computer 101 to the LAN 102. The computer 101 can perform data communication with the printing apparatus 103 via the LAN I/F 206.

A USB I/F 207 is used to connect the external device having a USB terminal. For example, a keyboard or mouse having a USB terminal can be connected via the USB I/F 207.

The printing apparatus 103 will be described next. The printing apparatus 103 is an apparatus having a function of executing a print process on a recording medium such as a paper sheet based on data transmitted from the computer 101. The printing apparatus 103 comprises a printer or multi-functional peripheral equipment. The storage apparatus 104 is connected to the printing apparatus 103 to temporarily store various kinds of information received from the computer 101.

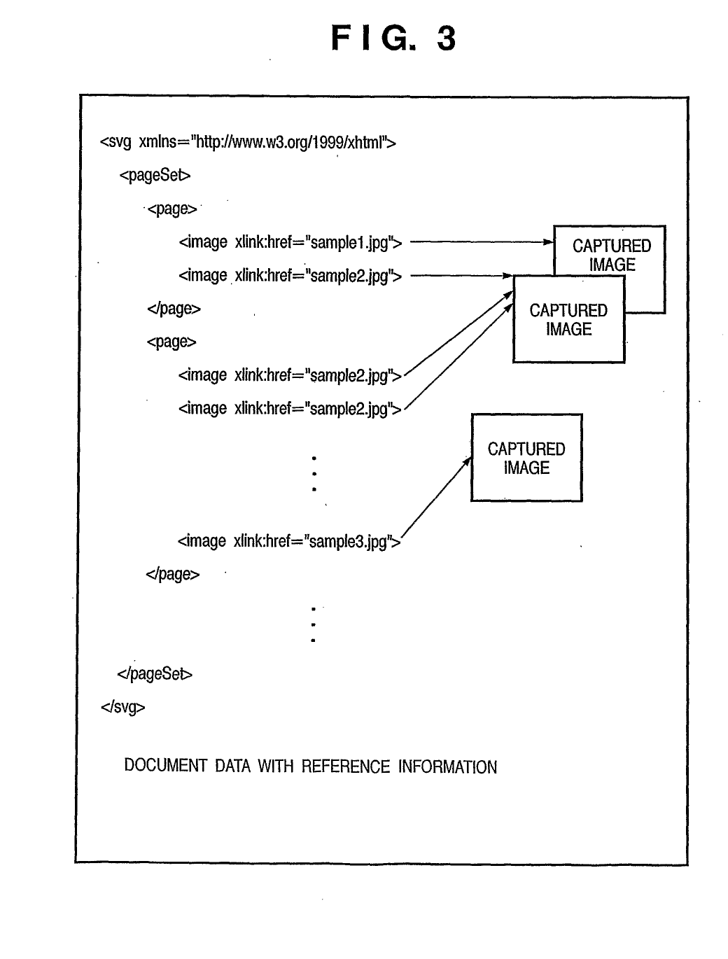

FIG. 3 is a view showing an arrangement example of a document file (document data) to be handled by the computer 101 according to this embodiment. Referring to FIG. 3, a document file in this embodiment is described in XML, but may be described in another markup language.

The document data shown in FIG. 3 contains pieces of link information representing links to image data (image files) serving as external files (pieces of reference information). For example, link information <imagexlink:href=“sample1.jpg”> represents a link to an image file named “sample1.jpg”. The image file at a link destination indicated by link information is stored in the storage unit 205. A plurality of links are set for an image file named “sample2.jpg”. The link destination may be data stored in the storage device which stores the documents, or data stored in another storage device.

The document file shown in FIG. 3 is stored in the storage unit 205, and loaded into the RAM 203 under the control of the CPU 201 as needed. In the following description, the computer 101 combines a document file shown in FIG. 3 and image files linked in this document file, and transfers the combined data to the printing apparatus 103. Note that since a data protocol for the printing apparatus 103 is not especially limited, a description thereof will be omitted.

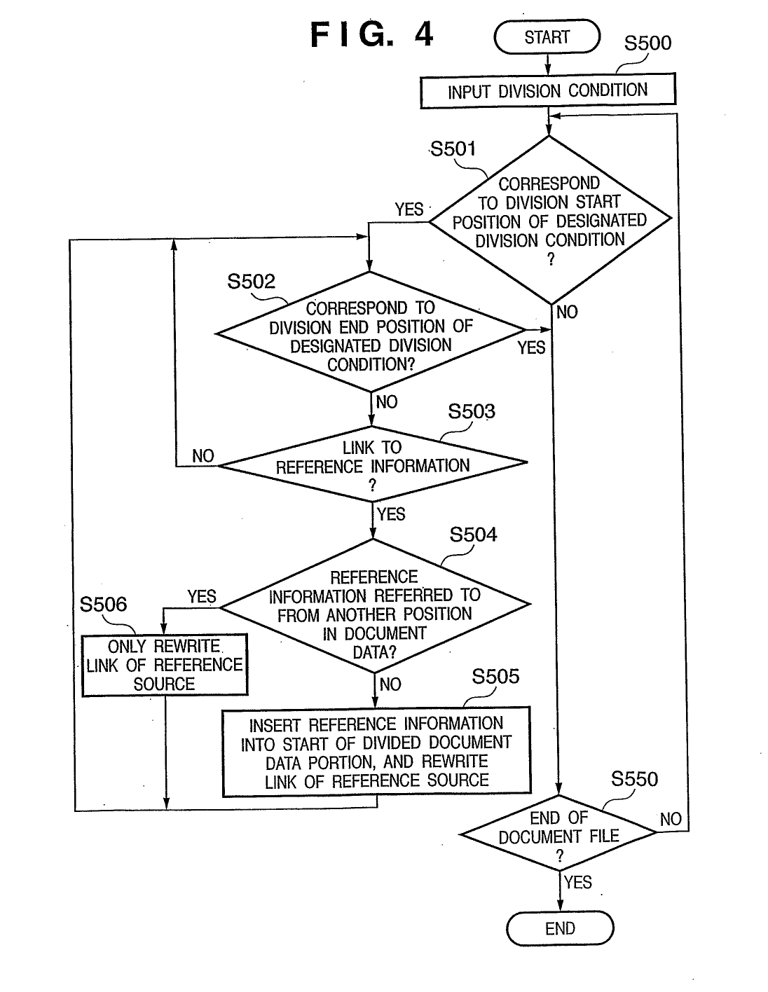

FIG. 4 is a flowchart showing processing executed by the computer 101. A program or data for causing the CPU 201 to execute processes in accordance with all flowcharts to be described later, including the flowchart shown in FIG. 4, is stored in the storage unit 205, and loaded into the RAM 203 under the control of the CPU 201 as needed. When the CPU 201 executes the processes by using the loaded program or data, the computer 101 executes the following processes.

First, a document file (having the arrangement shown in FIG. 3) loaded into the RAM 203 is divided into a plurality of divided files. The operator of the computer 101 is prompted to input a dividing condition representing a division position to select the dividing condition. The operator performs the selection operation using, e.g., a keyboard or mouse connected to the USB I/F 207. In this embodiment, the document file is divided into elements (to be referred to as page division units hereinafter) each of which is sandwiched between tags <page> and </page>. In this embodiment, since the operator designates the dividing condition to divide the document file into the page division units, the CPU 201 accepts this condition in step S500.

In step S501, the CPU 201 sequentially refers to a content from the start of the document file, and checks whether the start position (division start position) of the page division unit has been detected. In this embodiment, the CPU 201 checks whether the tag <page> has been detected. If YES in step S501, the process advances to step S502. If NO in step S501, the process advances to step S550. In step S550, the CPU 201 checks whether a current reference portion is the end position (e.g., the EOF position) of the document file. If YES in step S550, the process ends. If NO in step S550, the process returns to step S501, and the referring process is continued.

In step S502, the CPU 201 checks whether the end position (division end position) of the page division unit has been detected. In this embodiment, the CPU 201 checks whether the tag </page> has been detected. If YES in step S502, the process advances to step S550. If NO in step S502, the process advances to step S503.

In step S503, the CPU 201 refers to a description following the tag <page> detected in step S501, and checks whether the link information is written. If NO in step S503, the process returns to step S502, and the CPU 201 checks whether a current reference portion is the tag </page>. If NO in step S502, the process advances to step S503 again, and the referring process is continued. That is, in steps S502 and 5503, the CPU 201 can check whether the link information is written between the tag <page> detected in step S501 and the tag </page> immediately after the tag <page>. If YES (if the link information has been detected) in step S503, the process advances to step S504.

In step S504, the CPU 201 checks whether the image file indicated by the link information detected in step S503 is the image file which has been already merged (included) into the page division unit. The merging process of the image file will be described later. Noted that the term “merge”, used in this and following embodiments, means generally “package”.

If NO in step S504, the process advances to step S505. In step S505, the CPU 201 merges the image file indicated by the link information detected in step S503 into a position where is immediately before the tag <page> detected in step S501. In step S505, the CPU 201 also updates the link information such that the link information detected in step S503 indicates the merged position. As a result, the page division unit can be updated.

In order to check whether image files are the same each other, for example, the CPU 201 only needs to check whether their names are the same.

If YES in step S504, the process advances to step S506. In step S506, the page division unit is updated by updating the link information detected in step S503 so as to indicate the merged image file.

After step S505 or S506, the process returns to step S502, and the subsequent processes are repeated.

As described above, the processes shown in the flowchart of FIG. 4 are performed for one document file. After performing all processes according to the flowchart shown in FIG. 4, following processing is performed for the page division unit with the link information of the page division units in one document file. This is, when the link destination indicated by the link information does not indicate an image file which has been merged into the page division unit, the image file indicated by the link information written in the page division unit is merged into the start of this page division unit. Furthermore, in this case, the destination indicated by the link information is changed to indicate the merged position.

When the image file indicated by the link information has been already merged into the page division unit, this link information is updated to indicate the merged image file.

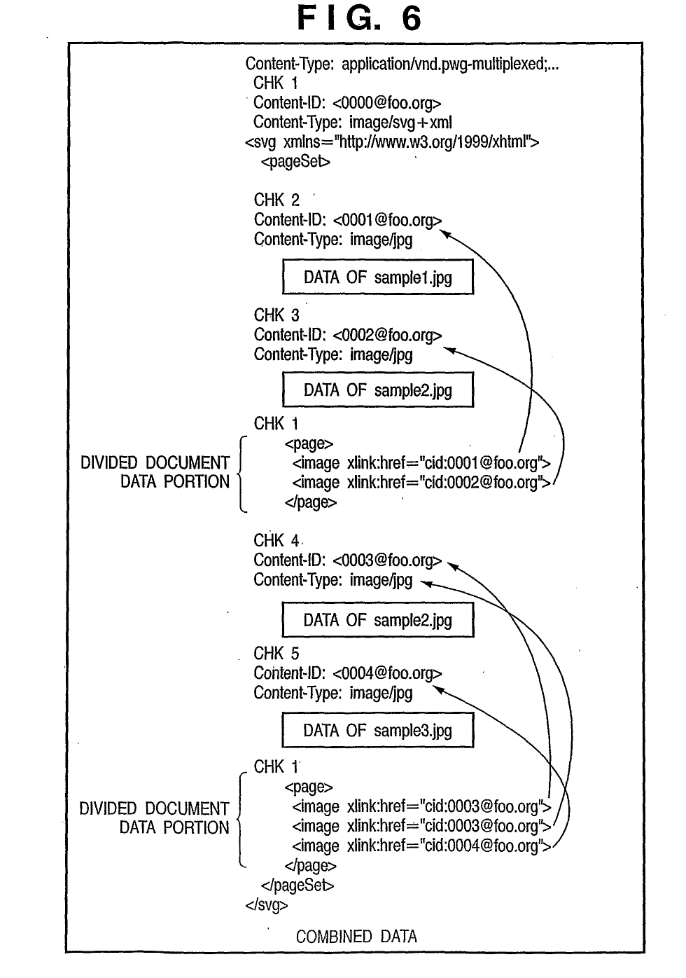

FIG. 6 is a view showing an arrangement example of a document file obtained by updating the document file shown in FIG. 3 in accordance with the flowchart of FIG. 4. Referring to FIG. 6, the merged image file portion is referred to from a reference source by an identifier “cidxxx”. The format of the identifier is not limited to “cidxxx” so long as the merged image file portion can be uniquely identified. In the second page division unit, pieces of the link information are written so as to refer to the same image file from the plurality of reference sources.

The document file generated as described above is then transmitted to the printing apparatus 103. As exemplified by FIG. 6, since the above-described document file is generated by the MIME, of course, the printing apparatus 103 has the arrangement complying with the MIME.

The information processing apparatus according to this embodiment may be applied to not only the computer 101 but also an apparatus having a memory capacity smaller than that of the computer 101, such as an image capturing apparatus such as a digital camera, a PDA, a cellular phone, and the like. That is, since the processes, shown in FIG. 4 aim at minimizing the size of a document file to be generated, a more preferable result can be obtained when the apparatus having a small memory capacity executes the processes according to the flowchart shown in FIG. 4.

In this embodiment, the document file is divided into elements each of which is sandwiched between the tags <page> and </page>. However, this invention is not limited to this. The document file may be divided into elements dividable according to the structure of the document file.

### Second Embodiment

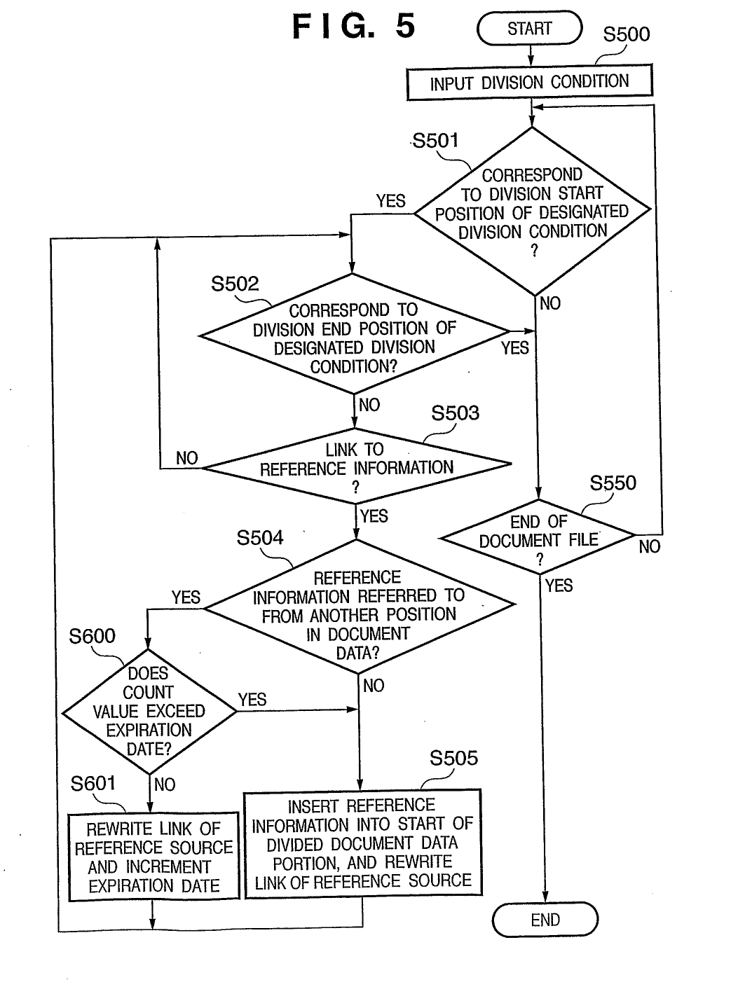

FIG. 5 is a flowchart showing processing executed by the computer 101. The second embodiment is different from the first embodiment in that a page division unit is updated based on an expiration range (expiration range information) set for an image file. The same step numbers as in FIG. 4 denote the same steps in FIG. 5, and repetitive description will be omitted.

In this embodiment, a maximum expiration range is set in advance. Of course, an operator may change the maximum expiration range using a keyboard or mouse as needed. The maximum expiration range may be same as the number of partitions of a document file, or the number of a given divided element when the document file is divided at portions dividable according to the structure of the document file. In this embodiment, the maximum expiration range is set as, e.g., 2. Within the maximum expiration range, external data is kept held to avoid redundantly referring to the same external data, and after the maximum expiration range, the external data is temporarily deleted. This prevents a memory from being occupied for a long time. For example, when one external data is referred to from the first, second, and 100th pages, the external data is deleted outside the maximum expiration range, and then merged (included) again when analyzing the 100th page.

In step S600, a CPU 201 counts the number of page division units which have been referred, and then determines whether the count value exceeds the expiration range. If YES in step S600, the process can advance to step S505. If NO in step S600, the process advances to step S601. In step S601, the same process as in step S506 is executed, and the expiration range is incremented by one.

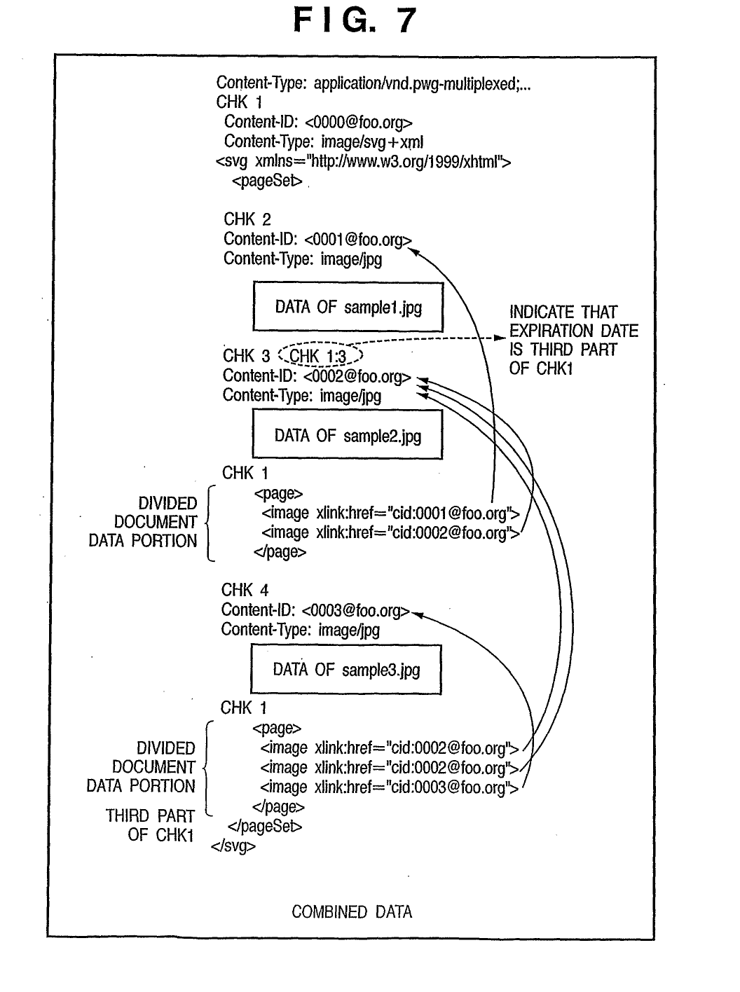

FIG. 7 is a view showing an arrangement example of a document file obtained by updating the document file shown in FIG. 3 in accordance with the flowchart of FIG. 5. Referring to FIG. 7, an image file indicated by link information is merged into the start of a page division unit. Since the second part of CHK1 refers to an image file (sample2.jpg), the image file (sample2.jpg) is merged and referred to. In this case, the expiration range of the merged image file (sample2.jpg) is 1.

The third part of CHK1 also refers to the image file (sample2.jpg). Hence, the CPU 201 determines whether the third part of CHK1 refers to the merged image file (sample2.jpg). When the third part of CHK1 refers to the merged image file (sample2.jpg), the expiration range of the merged image file (sample2.jpg) becomes “2”. Since the expiration range does not exceed the preset maximum expiration range “2”, the third part of CHK1 refers to the merged image file (sample2.jpg). A character string “CHK1:3” is added as the expiration range to the image file (sample2.jpg). This means that the image file is effective till the end of the third part of CHK1. In this embodiment, the character string “CHK1:3” is used. However, any character string may be used as long as the expiation range can be identified. For example, a character string “cid:0000@foo.org/3”, or the expiration range, i.e., “2” may be used. In this case, the maximum expiration range is “2”. Hence, even when the fourth part of CHK1 refers to the image file (sample2.jpg), the merged image file (sample2.jpg) is not referred to, but the image file (sample2.jpg) is merged again and referred to.

In the above-described embodiments, the link information in the document file is detected for each file divided under the designated division condition. Hence, the image file is not redundantly merged even when the same information is referred to from a plurality of portions of the divided file. Since the image file is merged into the start of each divided file, it is known that the image file inserted into the start of the divided file is not necessary after completely processing the divided file.

When the expiration range is added to an image file referred to from a plurality of divided files, the same image file need not be merged a plurality of times only within the expiration range.

Therefore, the document file and the image file can be combined without holding duplicated information as much as possible, in a data format in which the processes can be sequentially performed even by a device with a small resource.

### Third Embodiment

The OPC (Open Packaging Conventions) specification in the Office Open XML format which has been internationally standardized by the TC45 technical committee in the Ecma International committee serving as an information and electronics technical standardization organization defines how to archive a content, a resource, and metadata in the ZIP file format. In the following description, such archiving technique is used.

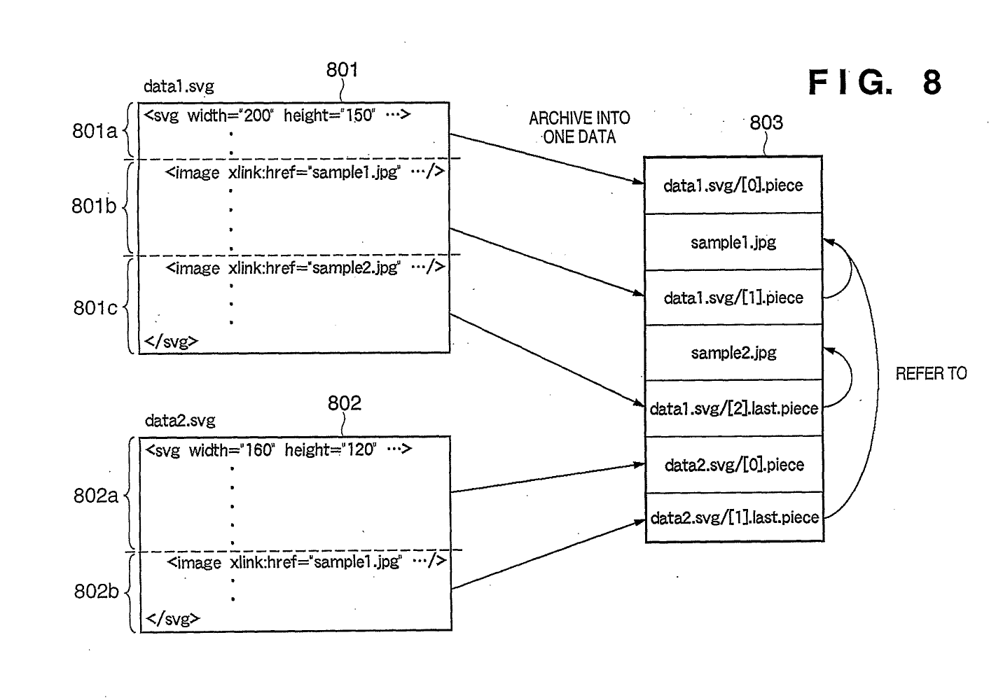

FIG. 8 is a view showing document data archived (included) by the computer 101 according to the third embodiment. Referring to FIG. 8, reference numerals 801 and 802 denote document files described in XML, each of which contains link information. The document files 801 and 802 respectively have file names “data1.svg” and “data2.svg”.

In this embodiment, the system shown in FIG. 1 is also used.

The third embodiment is different from the first embodiment in that a plurality of files such as document files and image files are archived into one file in accordance with the OPC specification.

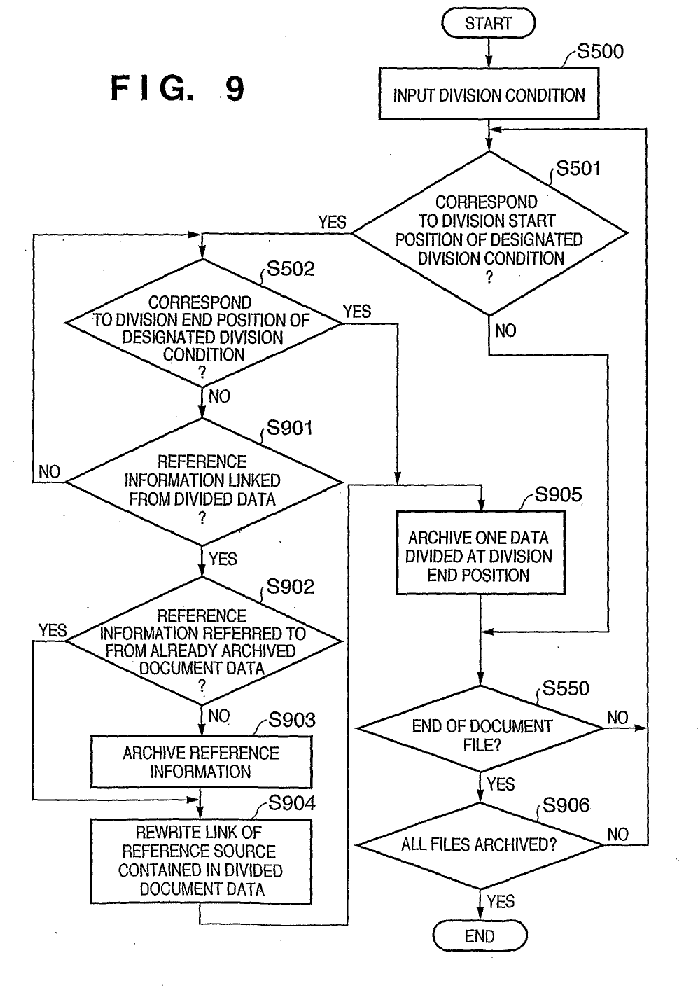

FIG. 9 is a flowchart showing processing executed by the computer 101 which archives the plurality of files such as the document files and image files into one file. Note that in FIG. 9, the same step numbers denote the steps that execute the same processing as in FIG. 4, and these steps will be briefly explained.

In this embodiment, the document files and image files to be archived are set in advance. However, an operator may select them using, e.g., a keyboard or mouse. Processes for the document files 801 and 802 shown in FIG. 8 will be described in accordance with the flowchart shown in FIG. 9. Of course, almost the same processes according to the flowchart shown in FIG. 9 can be performed even when other files are used.

In step S500, the CPU 201 accepts the division condition of the document files 801 and 802. In this embodiment, each divided file (divided document file) contains at most one link information.

The document files 801 and 802 are then processed one by one. To simplify the explanation, assume that the document file 801 and the document file 802 are sequentially processed. However, almost the same processes can be performed even when reversing this order.

In step S501, a CPU 201 sequentially refers to a content from the start of the document file 801, and checks whether the start position of the document file 801 or a start element position (division start position) containing an attribute “xlink:href” has been detected. Referring to FIG. 8, the start tag of an image element and the start portion of the document file correspond to the division start positions.

If YES in step S501, the process advances to step S502. If NO in step S501, the process advances to step S550.

In step S502, the CPU 201 checks whether the end position of the document file 801 or the position (division end position) immediately before a start element position containing the attribute “xlink:href” has been detected. Referring to FIG. 8, portions indicated by dotted lines and the end portion of the document file correspond to the division end positions.

If YES in step S502, the process advances to step S905. If NO in step S502, the process advances to step S901.

In the following description, data sandwiched between the division start position detected in step S501 and the division end position detected in step S502 is called a divided document file.

In step S901, the CPU 201 checks whether the divided document file contains the link information. If YES in step S901, the process advances to step S902. If NO in step S901, the process returns to step S502.

In step S902, the CPU 201 checks whether an image file (reference information) serving as a link destination indicated by the link information written in the divided document file has been linked from an already archived divided document file. This step is executed by checking whether the name of the image file serving as the link destination indicated by the link information written in the divided document file is the same as that of the image file indicated by the link information written in the already archived divided document file.

If YES in step S902, the process advances to step S904. If NO in step S902, the process advances to step S903.

In step S903, the CPU 201 archives the image file (reference information) indicated by the link information written in the divided document file.

In step S904, the CPU 201 rewrites the link information written in the divided document file. That is, the link information is rewritten so that the link destination indicated by the link information is the image file archived in step S903 or the image file (having the same file name as the image file indicated by the link information written in the divided document file) linked from the already archived divided document file.

In step S905, the CPU 201 archives the divided document file. Assume that when archiving the file, the file is merged into the already archived file to generate one archive file.

Referring to FIG. 8, a divided document file 801a at the start of the document file 801 is archived as a file name “data1.svg/[0].piece”. A next divided document file 801b is archived as a file name “data1.svg/[1].piece”. An image file “sample1.jpg” indicated by the link information written in the divided document file 801b is archived and merged into the above-described archive file. The link information in the divided document file 801b is rewritten to indicate the image file “sample1.jpg” in the archive file.

A next divided document file 801c is archived as a file name “data1.svg/[2].last.piece”. An image file “sample2.jpg” indicated by the link information written in the divided document file 801c is then archived and merged into the above-described archive file. The link information in the divided document file 801c is rewritten to indicate the image file “sample2.jpg” in the archive file.

In step S550, the CPU 201 checks whether the end position of the document file 801 is detected. If YES in step S550, the process advances to step S906. If NO in step S550, the process returns to step S501.

In step S906, the CPU 201 checks whether all the files are archived. If YES in step S906, the process ends. If NO in step S906, the process returns to step S501. In this case, since the document file 802 has not been archived, the processes after step S501 will be executed for the document file 802.

Referring to FIG. 8, a divided document file 802a at the start of the document file 802 is archived as a file name “data2.svg/[0].piece”, and merged into the above-described archive file.

A next divided document file 802b is archived as a file name “data2.svg/[1].last.piece”. An image file “sample1.jpg” indicated by the link information written in the divided document file 802b is linked from the already archived divided document file 801b. Hence, in this case, the image file “sample1.jpg” is not archived again. Then, the divided document file 802b is merged into the above-described archive file. The link information in the divided document file 802b is rewritten to indicate the image file “sample1.jpg” in the archive file.

With these processes, an archive file 803 is generated as shown in FIG. 8. The determination rules of each partial data in the archive file 803 and a data name are set in accordance with the OPC specification. With such archiving processes, even a device with a small resource can sequentially process each partial data in the archive file 803 without wastefully accumulating data, by processing sequentially each partial data in the archive file 803 from upper partial data to lower partial data.

### Other Embodiment

The objects of the embodiments are also achieved by the following method. A storage medium (or recording medium) which records software program codes to implement the functions of the above-described embodiments to a system or apparatus. The computer (or CPU or MPU) of the system or apparatus reads out and executes the program codes stored in the storage medium. In this case, the program codes read out from the storage medium themselves implement the functions of the above-described embodiments. The storage medium that stores the program codes constitutes the present invention.

When executing the program codes read out by the computer, the operating system (OS) running on the computer wholly or partially executes actual processing on the basis of the instructions of the program codes, thereby implementing the functions of the above-described embodiments.

The program codes read out from the storage medium are written in the memory of a function expansion card inserted to the computer or a function expansion unit connected to the computer. The CPU of the function expansion card or function expansion unit wholly or partially executes actual processing on the basis of the instructions of the program codes, thereby implementing the functions of the above-described embodiments.

The storage medium to which the present invention is applied stores program codes corresponding to the above-described procedures.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2006-045860, filed Feb. 22, 2006 and No. 2007-007459, filed Jan. 16, 2007 which are hereby incorporated by reference herein in their entirety.

1. An information processing apparatus which processes document data which contains link information representing a link to external data, comprising:
determination unit adapted to determine, when generating a plurality of divided document data by dividing the document data, whether the link information is written in each divided document data; and
updating unit adapted to update the divided document data determined by said determination unit to contain the link information, by including the determined divided document data and the external data indicated by the link information, and changing the link destination indicated by the link information to the included external data,
wherein the external data contained in the divided document data updated by said updating unit is the link destination indicated by the link information in the divided document data within a range set in advance.

2. The apparatus according to claim 1, wherein the divided document data is generated based on a structure of the document data.

3. The apparatus according to claim 1, wherein the external data indicated by the link information contained in the divided document data is included into a start of the divided document data.

4. The apparatus according to claim 1, further comprising transmission unit adapted to transmit, to an image forming apparatus, the divided document data updated by said updating unit.

5. The apparatus according to claim 1, wherein when the external data indicated by the link information written in the divided document data is the same as a link destination indicated by link information contained in another divided document data, said updating unit updates the link destination indicated by the link information of the another divided document data to the included external data.

6. (canceled)

7. An information processing method executed by an information processing apparatus processes document data which contains link information representing a link to external data, comprising:
a determination step of determining, when generating a plurality of divided document data by dividing the document data, whether the link information is written in each divided document data; and
a updating step of updating the divided document data determined in the determination step to contain the link information, by including the determined divided document data and the external data indicated by the link information, and changing the link destination indicated by the link information to the included external data,
wherein the external data contained in the divided document data updated in the updating step is the link destination indicated by the link information in the divided document data within a range set in advance.

8. A computer program for causing a computer to execute an information processing method of claim 6.

9. A computer-readable storage medium storing a computer program of claim 7.
